(19) United States
(12) Patent Application Publication
(10) Pub. No.: US 2014/0278704 A1
(43) Pub. Date: Sep. 18, 2014

(54) SYSTEM AND METHOD OF SHIPPING SCHEDULING INVOLVING PARALLEL PORT OPERATIONS USING PREPOSITIONED VESSELS

(71) Applicants: Luis D. ELIZONDO, Stevensville, MD (US); Elton John ROBERT, Stevensville, MD (US); Atmar Keith ROBERT, Houston, TX (US)

(72) Inventors: Luis D. ELIZONDO, Stevensville, MD (US); Elton John ROBERT, Stevensville, MD (US); Atmar Keith ROBERT, Houston, TX (US)

(21) Appl. No.: 14/217,926

(22) Filed: Mar. 18, 2014

Related U.S. Application Data
(60) Provisional application No. 61/800,342, filed on Mar. 15, 2013.

(51) Int. Cl. G06Q 10/06

(52) U.S. Cl. CPC G06Q 10/06313
USPC 705/7.23

(57) ABSTRACT

A method and system for scheduling vessels among a number of shipping companies to obtain parallel transport cycle as part of a vessel and voyage assignment scheduling system. Port laytime and parallel port service cycle time is scheduled efficiently by port operators by providing a berth for an inbound vessel and the transfer of crew from an inbound vessel to an outbound vessel already pre-serviced for departure such that the crew is not required to remain at port during the port service cycle. Unloading of cargo and reloading of cargo on an inbound vessel is performed prior to the timing of the crew transfer so that the crew transfers to the pre-serviced vessel and exit support system to proceed to the next port of call without minimum amount of delay in the port at which they arrive.

### FIELD OF THE INVENTION

The invention relates to a system and method of shipping scheduling involving parallel port operations using prepositioned vessels and preloaded vessels at ports to effect a logistical approach in port operations that minimizes port turnaround times, optimizes cargo throughput and creates efficiencies in vessel movements and cargo handling.

### DESCRIPTION OF RELATED ART

Sea cargo, which is carried by vessels between ports, includes all types of freight transported by a vessel other than passengers. The majority of sea cargo is transported in shipping containers and shipped by container ships or vessels. Container ships are designed to hold a substantial number of containers in a storage area below deck, comprised of a series of designated cells with vertical guide rails. These cells and their vertical guide rails have made the loading and unloading of containers very efficient. Above deck, container ships have also been designed to handle additional containers stacked on top of each other, up to seven containers high in some instances.

The conventional container-shipping system begins with loading a container ship at a port or terminal. After loading the containers, the vessel follows a route that may include ports of call at one or more terminals where the containers are to be delivered and other containers are to be picked up. The container terminals handle multiple vessels that are serviced by one or more quayside cranes, capable of handling loads of up to 40 tons. Once berthed at the container terminal, the quayside crane(s) unload and reload containers from/onto the container vessel. The quayside crane(s) may simultaneously load and unload containers in order to save port time.

Marine transportation scheduling has been known to be performed using manual analysis of available options with the assistance of spreadsheets. Modernization of that process has involved suing a computer application for optimization of transportation scheduling resulting in the assignment of vessels in an available fleet to perform a set of voyages. See U.S. Pat. No. 8,019,617 for example. The vessels may differ in size, shape, capacity, cost and intended use by the vessel owner. Accordingly, typical variables to be considered for scheduling are the capacity of each vessel in the fleet to be scheduled, including specific characteristics of each vessel such as draft and vessel capacities and dimensions, the port specifications to which the vessels travel, the loading and unloading restrictions for containers from each vessel at the ports, which can have different physical limitations such as maximum draft, maximum vessel length and width, etc.; and availability of the vessels at any given time as determined by existing contracts, current location, projected use and other vessel attributes such as speed of the vessel, fuel consumption, etc.

Various models and algorithms have been proposed for optimizing transportation scheduling of vessels, however the scheduling results in assigning vessels for transshipment of containers, for example, beginning from one port, optionally to intermediate ports, and then to a destination port and back, as one cycle of the vessel's route.

### SUMMARY OF THE INVENTION

In the past, the variables effected by port operations with respect to scheduling predictable wait times of vessels at ports has been difficult to predict with consistency. Part of a ship's assigned route or cycle time takes place when an inbound vessel approaches a port, such as when the vessel and crew are required to wait in line, offshore, for port access. This is known as offshore laytime or being in an offshore queue. Offshore laytime is contingent upon a particular port's ability to process throughput, seasonal market demands, and global market conditions. According to the particular port and other variances, offshore lay time may range from 0 to 14 days or more. In one example, under normal market conditions, the Port of Houston may see up to 7 days of offshore laytime during peak months, but an average of 3 days on an annual basis. This is a common event throughout the industry at major ports. Even though offshore laytime is not a constant, it has a significant negative impact for industry when it occurs.

Another substantial component of a vessel's scheduling deals with the port laytime associated with waiting for unloading and reloading of cargo, for example, during which time the captain and crew of the inbound vessel are required to be in hiatus.

Port turnaround time, which includes both offshore laytime and dockside service time or port laytime is one of the many factors which is considered in the scheduling of shipping. Idle transport time has significant negative impacts for all participants in a supply chain of the cargo, including the shipping companies, port operators and shippers.

According to the system and method of the invention, prepositioned vessels are made available for the preloading of outbound cargo to minimize idle cargo transport inefficiencies in the conventional cycle of port operations. Parallel port operations using prepositioned vessels and preloaded vessels at ports are used in a logistical approach to minimize port turnaround times, optimize cargo throughput at the port and create efficiencies in vessel movements in shipping scheduling and transportation of cargo as well as cargo handling in port.

The prepositioned vessels discussed herein include existing ships or vessels known in the maritime industry as container ships, and also bulk cargo ships. As discussed herein, prepositioned vessels also includes vessels having a detachable command superstructure (which controls and navigates the vessel) that allows the command superstructure to be manually separated from its hull and transferred to another one of a plurality of compatible hulls. See U.S. Pat. No. 7,487,735, which shows vessels which have detachable command superstructures.

The pre-positioning of a vessel at a container terminal allows containers to be pre-loaded so that when an inbound vessel berths at the container terminal, the captain and crew depart on an outbound vessel that has been prepared for departure by preloading of cargo and servicing of the vessel. The inbound vessel, now minus its crew, and optionally its command superstructure if the superstructure has been transferred to the outbound vessel, is unloaded and loaded according to the priorities assigned by the terminal operators. One consideration is that this process permits added flexibility to the terminal handling operations so that thorough inspection of cargo may be performed.

Upon arrival of the next inbound vessel, the process is repeated with the previous vessel (or another vessel) prepared for an outbound segment of a route. In repeating the process, the inbound vessel is moved to a berth for crew transfer and then moved again, if necessary depending on terminal operations, to a position for cargo unloading. The parallel port operations are able to be implemented with all of the afore-defined vessels.

The parallel port operations also allow the hull of a vessel which is preloaded to theoretically be loaded to its maximum capacity possible, prior to receiving a crew transfer from an inbound vessel. This should reduce the container terminal time by the amount of the average loading time, although this would be offset by the optional transfer of the command superstructure when using vessels having a detachable command superstructure. This reduced container terminal turnaround time, played out over dozens of routes and across years of operating time, generates substantial increases in throughput, revenue, and market share for shipping companies as well as terminal handling efficiencies.

The key stakeholders in the container shipping or bulk cargo shipping industry are generally classified as either vessel-related or port-related. The vessel-related stakeholders include shippers, shipping companies (liner companies for container ships), ship builders, and independent ship owners or entities. Port-related stakeholders include port authorities, port operators, and intermodal operators.

Shippers (e.g. the customers of shipping, typically manufacturing companies and retail companies or commodities companies) contract with shipping companies to deliver their cargo (work-in-progress or finished goods inventory, bulk cargo) to a specific port or destination at a fixed price. Liner companies mainly carry containerized cargo on regularly scheduled, published service routes and provide this information for shippers to use.

In implementation of the system and method of shipping scheduling of the invention, involving parallel port operations using prepositioned vessels, the number of ships required for a given liner service route will be greater than that required for conventional service on the route. This requirement for additional vessels can be made up from companies and other asset holders having available vessels. Use of additional vessels increases contract costs or new vessel acquisition costs with resultant increases in capital investment (of vessel assets). However, the economic model clearly shows the addition of these assets creates an exceptional new efficiency paradigm, effectively pays for the investments, streamlines the supply chain, and creates higher profits for all involved.

Port authorities are typically governmental entities or quasi-governmental entities that are formed by a legislative body to operate ports, terminals, and other port infrastructure. The port operator is responsible for managing and/or coordinating the movement of container traffic between the vessels and other intermodal operators (i.e., road, rail, and transshipment). Their objective is to make this movement of container traffic as efficient as possible, thereby minimizing the amount of time that a vessel spends in port. Container ports may have several container terminals, some private and some public, which provide a critical set of services to the liner industry. Container ports and terminals earn income by charging vessels from the container shipping companies for using their facilities.

Ports implementing the method and system of the invention will allow immediate and direct access to dockside service facilities upon arrival of an inbound vessel and provide proprietary berthing access upon arrival. Once the arriving vessel is secured at a berth assigned by the terminal operator, and the captain, crew and port pilot disembark and board a separate, additional vessel (as compared with the conventional route implementation) that has been pre-serviced (preloaded) and prepared for departure. Currently, in-port service cycles may take from 12 hours to 4 full days or more. As growth continues in the industry, so will the service cycles for conventional linear port cycles. By implementing the parallel port operations of the invention, this turnaround time factor that is removed from the conventional transport cycle will lessen the overall port servicing time. Further, proprietary berthing implemented by the ports will minimize the port laytime, port service cycle and promote a continuous flow process in the overseas cargo transit cycle.

When a vessel arrives in port where a preloaded and serviced vessel is provided, a transition involving parallel port processes occurs. The inbound vessel becomes a future prepositioned, preloaded and serviced vessel. A fully serviced preloaded and prepositioned vessel which existed at the port before the inbound vessel arrived becomes an outbound vessel ready for boarding and departure by the crew. Thus, the linear portion of the port servicing cycle is eliminated from the overseas transport cycle and replaced by a parallel component. Accordingly, the insertion of additional vessels clearly redefines conventional supply chain theory and efficiency for this industry.

In implementation of the system and method of shipping scheduling, port operations are no longer predicated upon fast turnaround for a vessel and crew who remain idle while the vessel is being unloaded/reloaded and serviced. Vital services provided by the terminal operators can be provided on a more flexible schedule. At this point the newly arrived vessel virtually becomes a “centralized distribution hub” for local intermodal transport systems, (i.e., trucking, rail/pickup, delivery operations). Inbound cargo can be offloaded directly onto intermodal systems for immediate delivery, staged for temporary storage, or secured for regulatory inspections. Once unloaded, the outbound cargo service cycle begins. Since significant time constraints have been eliminated in this cycle, it becomes an area of exceptional efficiency for port operations.

Another efficiency of port operations is achieved by implementation of the system and method of shipping scheduling of the present invention through the use of a dockside gantry crane component for dockside service. Due to the gantry cranes height, lift capacity and over vessel reach, there would virtually be no cargo too big to be loaded off from/onto any type of transport vessel. This presents a significant opportunity in heavily industrialized areas for port services. Gantry cranes are also suitable for vessels having a detachable command superstructure that controls and navigates the vessel and that is manually separable from and transferable from one hull to another compatible hull using the gantry crane.

Cargo containers can weigh up to 30,000 lbs. and are normally loaded/un-loaded one container at a time. The capacity of the gantry crane (640 tons or more) is much greater than conventional dockside service cranes. The technology for lifting two containers at a time already exists, however the vast majority of ports do not have the conventional dockside service cranes with the capacity to do this. The gantry crane envisioned for use in the system and method of the present invention will also have tandem or main lifting hoists. This permits, with the proper rigging, multiples of 4, 6, 8 or even 12 containers at a time to be handled in a single lift.

When port throughput increases to a point where a single gantry cannot keep up with normal operations, a second gantry can be added. The second gantry can be a lighter lift design and be dedicated to cargo handling operations. Both cranes can work in unison on a single vessel or on multiple separate vessels as needed. Contingent upon port design, additional cranes could also be added as long term port throughput demands continue to increase.

It is an object of the present invention to preposition vessels, optionally including vessels having a detachable command superstructure, at a first port or terminal for pre-loading of the vessel with respect to a captain and crew who are inbound to the first port or terminal on one vessel, and to provide a system for scheduling of the prepositioning of such vessels. The post-unloading of the inbound vessel occurs with respect to the captain and crew who piloted the inbound vessel and are able to leave such inbound vessel and depart on another vessel to a second port or terminal.

Still another object of the present invention is to provide a port operation that handles the unloading of a vessel without the necessity of delaying the crew and captain who have arrived inbound to the port or terminal so that the captain and crew may be available for an outbound voyage of a pre-loaded vessel that has been preloaded at same port or terminal before the arrival of the first inbound vessel.

A further object of the invention is to provide a method and system for scheduling the pre-loading and post-unloading of vessels as part of the port operations to enhance turnaround time of a captain and crew who are inbound to the port or terminal on one vessel to be post-unloaded and outbound with respect to a second vessel that the captain and crew boards for embarking to another port or terminal wherein the second vessel has been pre-loaded with respect to the arrival time at the port of the captain and crew on the first vessel.

These, together with other objects and advantages which will be subsequently apparent, reside in the details of construction and operation as more fully described and claimed hereafter, reference being made to the accompanying drawings forming a part hereof, wherein like numerals refer to like parts throughout.

### BRIEF DESCRIPTION OF THE DRAWINGS

FIG. 1 is a diagram of a conventional linear port cycle for an inbound vessel arriving at a port and leaving the port after unloading and reloading of cargo;

FIG. 2 is a diagram of a parallel port cycle of the method of the invention for an inbound vessel arriving at a port, also showing vessel transitioning allowing for a crew to transfer vessels and depart on another, preloaded, and fully serviced vessel;

FIG. 3 is a diagram of a system of the invention used in scheduling of shipping among shipping companies or entities, port or terminal operators and shippers by including the parallel port cycle of the method of the invention.

### DETAILED DESCRIPTION OF THE PREFERRED EMBODIMENTS

FIG. 1 shows the prior art linear transport portion of a shipping cycle at a port for an arriving inbound vessel. First, at step 1, approximately three days before arriving at the port, a notification of pending arrival is sent to the port terminal operator. Depending on the operation of the port, one to seven days of port laytime may occur in step 2 while the inbound vessel waits for port handling facilities to be available such as the unloading facilities and/or berthing spots for the vessel at which the cargo is able to be unloaded, for example by the quayside cranes. Finally, after the port laytime elapses, the vessel enters the port system at step 3 and proceeds to berthing in the vessel arrival block at step 4.

In a linear port cycle as shown in FIG. 1, the cargo is unloaded from the vessel at step 5 and the outbound cargo is reloaded onto the vessel at step 6, followed by vessel preparations, such as providing provisions and fuel at step 7. The linear port service cycle may take from one to four days depending on the efficiency of the port handling operation. Finally, the vessel departs at step 8 and the vessel exits the port system at step 9 and calls upon the next port at step 10 as an inbound vessel to the next port.

By comparison, in implementation of the system and method of shipping scheduling according to the present invention, turnaround time is minimized at the port. As shown in FIG. 2, step 21 is similar but includes providing notice of arrival while providing sufficient time for the terminal operator to preload and fully service an anticipated outgoing vessel which the crew will board after disembarkation. Also, the terminal operator will reserve priority berthing for the incoming vessel to minimize the days of port laytime that may otherwise occur in step 22. The port laytime may be eliminated or significantly reduced depending on the factors permitting immediate berthing of the vessel which arrives in step 23 and is berthed at the port at step 24.

In the embodiments of the invention, the berthing at step at 24 is performed at a position which does not necessarily require the unloading of cargo. Rather, one port time minimizing achievement of the vessel berthing step 24 involves permitting the crew and captain, etc. to transfer at step 25 to a fully serviced, preloaded vessel which has been pre-positioned for the outbound voyage under command of the transferred crew. As a result of the transfer of the crew to the second vessel, the elapsed time from vessel arrival at the port to vessel departure (of a different vessel) at step 26 may require only four-six hours or longer. Subsequently, the pre-serviced vessel is able to exit the port system at step 27 and proceed to the next port of call at step 28, thus completing the parallel transport cycle and saving the potential of several days of port laytime and port service time, as shown in a comparison with the comparable steps of FIG. 1.

In FIGS. 2, the unloading of cargo in step 30 in the parallel port service cycle is able to be accomplished after the crew has transferred to the pre-serviced vessel in step 26. Additionally, the reloading of cargo onto the vessel which was inbound to the port can be accomplished after in step 31 after the crew has transferred to the outbound vessel that has been serviced in step 32. Further, there is no wait for vessel preparation for an outbound voyage by the transferred crew which transitions from the first inbound to the pre-serviced vessel at step 26. Potentially, 2-11 days can be eliminated by employing the parallel port service cycle shown in FIG. 2.

By transferring the crew from an inbound vessel to an outbound vessel, the crew's laytime is reduced significantly. Vessels moving from one port to the next port are required to have a crew and the delay of the crew's ability to pilot a ship from one port to the next which is caused by the port handling operations is significantly curtailed by the embodiments of the invention shown in FIG. 2.

A system for scheduling the voyages of ships including the parallel transport cycle of FIG. 2 is shown in FIG. 3. The system is able to output a schedule of shipping for vessels that is reduced by a number of days at compared with conventional scheduling (shown in FIG. 1) in terms of port laytime and port service time. Incorporating the parallel transport cycle of the embodiments of the invention in an existing system for shipping scheduling (in place of the linear transport cycle used in the prior art) requires resetting the range of the variables assigned to and relating to the port laytime and port service time with the result that the route shipping time is decreased overall, as compared with conventional shipping times for the same routes. However, the complexity of the scheduling of the shipping routes is not increased as a result, and therefore a substantial practical achievement in shipping scheduling that reduces time of shipment can be achieved by using the parallel port service cycle component in the shipping scheduling of vessels.

As shown in FIG. 3, a shipping company or an alliance of shipping companies 100 maintain a database in memory 110 including data 120 of the physical characteristics of the vessels such as the capacity, length and range, draft and width of the vessels. Additionally, the database 110 includes voyage data of the vessels 130, which includes current location data, next port of call information, and current constraints of each vessel, such as contract service commitments, scheduled maintenance requirements, etc. Users representing the shipping companies enter data into the memory 110 and update the data with a processor 140 and a network interface 150 including input/output devices as typically enabled by a computer with peripheral devices. The database 110 is shown to be connected through the computer or processor 140 to the Internet or an Intranet 10.

Another stakeholder in the shipping scheduling method and system of the embodiments of the invention are the port operators 200. Port operators work independently or together to provide and maintain a database in memory 210 including data of the port operations and vessel movements and placements within the ports and at the terminals during servicing. The data includes the vessel movements 220 within the port and terminals with respect to the available berths for priority berthing and, for example, available berths for loading and unloading of cargo using quayside equipment. Also, for management of the port operations, the data of the cargo 230 is stored in the database along with the associated shipper's data 240 in order to identify priority or dangerous cargo, as well as inspected and yet to be inspected cargo and its placement in vessels. The vessel movement data 220 tracks vessels which are prepositioned and pre-serviced in anticipation of an imminent outbound voyage, as well as berthing data identifying availability berths for incoming vessels. The shippers data 240 is stored in association with the cargo information 230 to track loading and unloading of the cargo in accordance with shipper's requirements.

The port operator's maintain the database and communicate with the shippers and the shipping companies as necessary. The data of the memory 210 is entered and updated continuously with a processor 250 and operating through a network interface 260 including input/output devices as typically enabled by a computer with peripheral devices. The stored data is shown to be connected through the computer or processor 250 to the Internet or an Intranet 10.

The use of an intranet connection enables data from the shipping companies and port operators to be maintained isolated from the internet, if thought necessary for security and confidentiality reasons. However, the network interfaces may provide connection with the internet, for example, using encrypting technology to maintain security according to the embodiments of the invention.

A management entity 300, which may be part of a shipping company or a port operating authority, also maintains a database in memory 310 including data which is a compilation of data provided by the shipping companies with respect to vessel data 320, such as the physical and voyage data maintained in memory 110. Additionally, the management company maintains the information of port data from the port operators 330 by connection with the port operator memory 210 through the intranet/internet.

According to one embodiment of the invention, a management entity manages the data from the shipping companies and the port operating authorities by maintaining the database in memory 310 through a private intranet connected to the port operators database and the shipping company's database. However, an internet connection for obtaining data and updating the memory 310 with a processor 340 and a network interface 350 is possible in which the input/output device enables a user to be connected through the computer or processor 340 to the Internet or an Intranet 10.

The management company, if necessary, is able to maintain the data from the shipping companies so that some or all of the data of the shipping companies is maintained confidentially with respect to each individual shipping company or entity in order to ensure confidentiality among the shipping entities with respect to the vessel assets in order to permit the sharing of data concerning the available ships or vessels for scheduling purposes. This is thought to also protect the shipping companies from disclosing confidential data regarding the vessel assets, which the shipping entities might not agree to sharing with other shipping companies, with whom they are on competition and cooperation at the same time when sharing the availability of their vessels within the alliance.

Similarly, the management entity 300 is able to manage the database including the port data from all of the ports obtained from the port operators 200 without sharing confidential data between port operators, if this is desired by the port operators participating in the scheduling system. According to embodiments of the invention, there is an advantage to having an independent management entity handling the entering and updating of overall data or information from sources whom might not otherwise share such data in order to implement the system and method of shipping scheduling of the invention and thereby gain the advantages of cost reduction and efficiency.

The efficiencies also benefit the shippers 400, who independently or together maintain individual or group databases of shipper data. According to one embodiment, a shipper 400 maintains data in a database stored in a memory 400 which includes cargo specifications 420 and the voyage requirements 430 of the cargo to be shipped and received at a port. The data stored in memory 410 is updated with new orders and the status of existing shipping contracts with a processor 440 and a network interface 450 including input/output devices as typically enabled by a computer with peripheral devices. The database is shown to be connected through the computer or processor 440 to the Internet or an Intranet 20.

If desired, one or more shippers are able to determine the available vessels through the management entity for all shipping companies participating in the system. Additionally, the port operators data is available, as needed.

As shown in FIG. 3, the scheduling system of the invention enables the management entity to arrange for availability of vessels among a number of shipping companies or entities participating in the system and include the ports also participating. The scheduling is performed in the same manner as conventionally performed with respect to vessels scheduled with port laytime variables calculated on the basis of linear transport cycles. However, the port laytime is calculated according to the present invention using parallel transport cycle times, which are significantly shorter than the comparable port laytimes of the linear cycles, as shown by the comparison of FIGS. 1 and 2. The scheduling anticipates the port operators being able to pre-position vessels to provide preloaded and pre-serviced vessels ready for departure following a vessel transition process as shown in steps 24-26 in FIG. 2. Additionally, the port operators communicate with the management entity to schedule the parallel port service cycle operations 30-32 as shown in FIG. 2 to achieve port laytimes that enhance efficiency of port handling operations.

Numerous other modifications and adaptations of the present invention will be apparent to those skilled in the art and thus, it is intended by the following claims, to cover all such adaptations with fall within the true spirit and scope of the invention. Claims

1. A system of scheduling vessels owned as assets under management of shipping entities that carry cargo for shippers between ports, comprising:
a first database stored in a first memory and linked to a first processor, said first processor being connected to a first network interface, said first database storing information of vessels to be considered for the vessel scheduling;
a second database stored in a second memory and linked to a second processor, said second processor being connected to a second network interface, and said second database storing port operation data relating to vessels that are serviced at said port when scheduled by said scheduling;
a third database stored in a third memory and linked to a third processor, said third processor being connected to a third network interface, said third database storing information of cargo to be shipped by vessels according to said scheduling that is provided by shippers; and
a fourth database stored in a fourth memory and linked to a fourth processor, said third processor being connected to a fourth network interface, said fourth database managing information of said first, second and third databases and scheduling vessels to include time at port in which parallel port operations are performed using prepositioned and preloaded vessels at said port and in which at said first port a first vessel with a respective crew who piloted the first vessel inbound to the first port transition to a second vessel bound for a second port and the first vessel inbound to the first port remains at the first port for subsequent unloading operations.

2. The system of scheduling vessels according to claim 1 wherein second vessel that the captain and crew boards for embarking to the second port is scheduled to have been preloaded and serviced prior to said first vessel arriving at said first port.

3. The system of scheduling vessels according to claim 1, wherein the first and second vessels have detachable command superstructure which controls and navigates the vessel and that allows the command superstructure to be manually separated from a hull of said first vessel and transferred to a second hull of said second vessel as part of said parallel port operations.

4. A method of scheduling vessels owned as assets and managed by shipping entities that carry cargo for shippers between a first and second port, comprising the steps of:
storing in a first database information of vessels to be considered for the vessel scheduling and updating the stored information with a first processor connected to a first network interface which includes a user terminal;
storing in a second database information of port operations relating to vessels that are serviced at said first port and updating with a second processor connected to a second network interface including a second user terminal;
storing in a third database information of cargo to be shipped by vessels according to said scheduling that is provided by shippers and updating the cargo information with a third processor connected to at least one third network interface including a third user terminal; and
managing a fourth database linked to a fourth processor that is connected to said first, second and third databases with a fourth network interface including at least one user terminal, and scheduling vessels by updating a time a vessel is in port which performs parallel port operations using prepositioned and preloaded vessels at said first port and in which at said first port a first vessel with a respective crew who piloted the first vessel inbound to the first port transition to a second vessel bound for a second port and the first vessel inbound to the first port remains at the first port for subsequent unloading operations.

5. The method of scheduling vessels according to claim 4 wherein said scheduling schedules a second vessel that the captain and crew boards for embarking to the second port so that said second vessel is scheduled to have been preloaded and serviced prior to said first vessel arriving at said first port.

6. The method of scheduling vessels according to claim 4, wherein the first vessel has a detachable command superstructure which controls and navigates the vessel and that allows the command superstructure to be manually separated from a hull of said first vessel and said scheduling assigns said second vessel to be a vessel having a hull being compatible with said detachable command superstructure when transferred to said hull of said second vessel as part of said parallel port operations.
